(19) United States
(12) Patent Application Publication
(10) Pub. No.: US 2012/0262378 A1
(43) Pub. Date: Oct. 18, 2012

(54) TOUCH FLAT PANEL MOBILE COMMUNICATION TERMINAL EQUIPPED WITH COMPUTER PROCESSING FUNCTIONS

(76) Inventor: Qing-Wen YANG, Taichung City (TW)

(21) Appl. No.: 13/084,771

(22) Filed: Apr. 12, 2011

(51) Int. Cl. G06F 3/041; G06F 3/02

(52) U.S. Cl. 345/169; 345/173

(57) ABSTRACT

A touch flat panel mobile communication terminal equipped with computer processing functions is actively connected to a computer host when started, and includes a screen touch unit, a basic processing unit, a multimedia output unit and a first transmitting/receiving unit. The computer host includes and is connected to a second transmitting/receiving unit. Through the first and second transmitting/receiving units, commands and input entered by users and desirably processed by the terminal are transmitted to the computer host for processing, and then processed data is sent back to the terminal for displaying. The terminal thus formed can be made slimmer and lighter at a lower cost, and has characteristics of portability and lower power consumption that all provide complete computer processing capability.

### FIELD OF THE INVENTION

The present invention relates to a touch flat panel mobile communication terminal equipped with computer processing functions that is low-cost, slimmer and lighter, easier to carry and power saving.

### BACKGROUND OF THE INVENTION

A conventional terminal is a device actively connected to a server when started. The server provides processing function to meet end-users' requirements and transmits data of processed results to a terminal screen to be displayed through a linked wire. Hence the terminal usually includes facilities such as a screen, a host and a keyboard. As a result, the terminal is bulky and portability suffers, and a lot of space is needed. With advances of global mobile communication services and technology, compact computers or notebooks with smaller size have been developed to gradually replace the conventional terminals. The computer can simulate terminal's operation mode through designed software. As the computer also has capability to execute other complex programs, to efficiently execute the complex software, the powerful hardware components are needed. This makes shrinkage the size of the computer or notebook difficult, and the improvement of portability is limited. To remedy this deficiency, many types of personal information products equipped with a function similar to notebooks have been developed in recent years, such as PDA, smartphone, tablet computer, iPod and the like. They all provide more desirable features such as slim size and light weight and greater portability by omitting some hardware elements. This results in downgrading of processing capability and lower practicality to meet the demands of multimedia applications that are increasingly popular nowadays.

Hence how to design a portable information product with a smaller size and lighter weight at a lower cost and comprehensive computer processing capability and consuming less electric power is one of the most important issues in the industry at present.

### SUMMARY OF THE INVENTION

The primary object of the present invention is to provide a touch flat panel mobile communication terminal equipped with computer processing functions, which is slim and light, easy to carry, low-cost and power saving, and also provides complete computer capability.

To achieve the foregoing object, the touch flat panel mobile communication terminal according to the invention includes a screen touch unit, a basic processing unit, a multimedia output unit and a first transmitting/receiving unit, and a computer host which includes and is connected to a second transmitting/receiving unit. The first and second transmitting/receiving units transmit commands and input entered by users and desirably processed by the touch flat panel mobile communication terminal to the computer host for processing, then the processed data is sent back to and displayed on the touch flat panel mobile communication terminal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of an embodiment of the invention.

### DETAILED DESCRIPTION OF THE PREFERRED EMBODIMENT

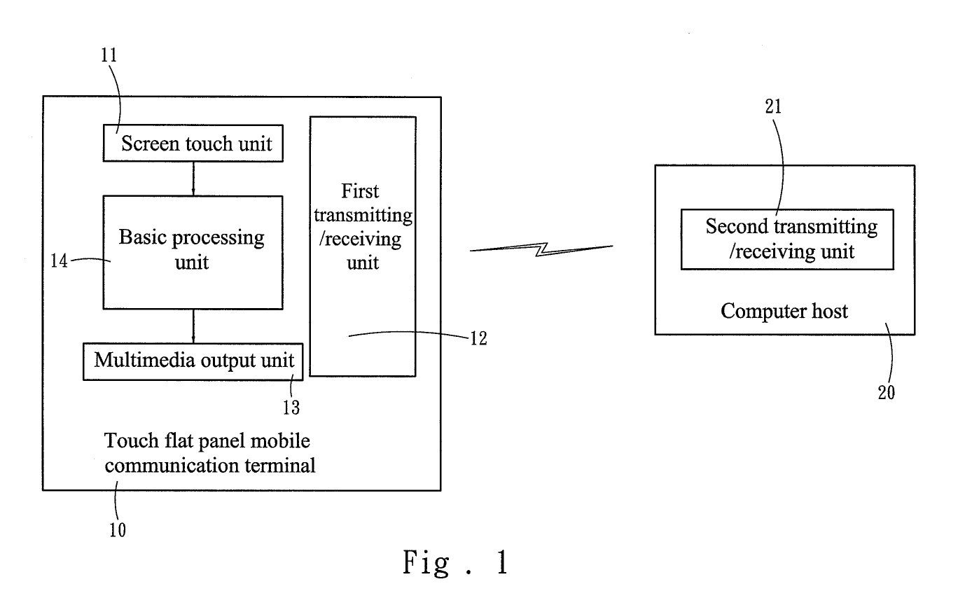

Please refer to FIG. 1 for an embodiment of the invention. The touch flat panel mobile communication terminal equipped with computer processing functions of the invention comprises a touch flat panel mobile communication terminal 10 and a computer host 20.

The touch flat panel mobile communication terminal 10 includes a screen touch unit 11, a basic processing unit 14 linked to the screen touch unit 11, a multimedia output unit 13 (such as a screen, speaker) linked to the basic processing unit 14, and a first transmitting/receiving unit 12 linked to the basic processing unit 14. The screen touch unit 11 is a human-machine interface, or may include an additional device selected from the group consisting of a keyboard, mouse, track ball, voice control interface and combinations thereof to allow a user to operate and control commands or input data.

The computer host 20 includes and is connected to a second transmitting/receiving unit 21. The computer host 20 may be a desktop computer, notebook, or server, and may be positioned nearby or remote from the terminal. The first and second transmitting/receiving units 12 and 21 may be connected via a wireless or wired network. The wireless network can be WiFi, WiMax, mobile communication network, Bluetooth or infrared communication to establish communication linkage wirelessly.

When in use, the user turns on the touch flat panel mobile communication terminal 10 to establish a direct connection to the computer host 20 (this is a technique known in the art, thus details are omitted therein). The screen touch unit 11 receives a control command or input data from the user, and the command or data is sent from the basic processing unit 14 via the first and second transmitting/receiving units 12 and 21 to the computer host 20 which correspondingly processes the input to generate multimedia data sent back to the touch flat panel mobile communication terminal 10 via the first and second transmitting/receiving units 12 and 21, the multimedia data being output through the multimedia output unit 13 to be accepted by the user. The multimedia data may be selected from the group consisting of audio, video, screen frames, and combinations thereof.

As previously discussed, the touch flat panel mobile communication terminal 10 of the invention requires a simpler internal structure by merely installing the screen touch unit 11, basic processing unit 14, multimedia output unit 13 (such as screen, speaker), and first transmitting/receiving unit 12, thus the size can be shrunk significantly. Through the first and second transmitting/receiving units 12 and 21, the multimedia data desirably processed by the touch flat panel mobile communication terminal 10 can be directly transmitted to the computer host 20 for processing, and then the processed data is sent back to and displayed on the touch flat panel mobile communication terminal 10. As a result, the touch flat panel mobile communication terminal 10 can be made slimmer and lighter to improve portability, and still can possess complete computer processing capability. Since the touch flat panel mobile communication terminal 10 does not need to perform any processing operation, it can save a lot of electric power, and make desirable features such as slim and light, portable, low-cost and power-saving possible.

In addition, since the touch flat panel mobile communication terminal 10 has the screen touch unit 11 (human-machine interface), the basic processing unit 14 linked to the screen touch unit 11 and the multimedia output unit 13 (such as screen, speaker) linked to the basic processing unit 14, the invention also can function as a standalone device to process simple games or computer programs.

As a conclusion, the touch flat panel mobile communication terminal 10 equipped with computer processing functions of the invention provides many benefits, notably:

First, the touch flat panel mobile communication terminal 10 does not execute operation required by the user, but transmit the required operation via the first and second transmitting/receiving units 12 and 21 to the computer host 20 which possesses complete computer capability, thus it is free from the constraints of the conventional personal mobile device, such as PDA, smartphone, iPad, tablet computer or the like that requires a battery or greater size to accommodate powerful CPU and a great amount of memory like a personal computer. Hence the touch flat panel mobile communication terminal 10 of the invention provides more complete and powerful computer functions.

Second, as the touch flat panel mobile communication terminal 10 does not execute operation required by the user, but transmit the required operation via the first and second transmitting/receiving units 12 and 21 to the computer host 20, it does not need to accommodate complicated hardware elements and can be made slimmer and lighter at a lower cost and has characteristics of portability and lower power consumption than the conventional computer or notebook.

Third, the touch flat panel mobile communication terminal 10 provides improved mobility and portability than the conventional terminals.

Fourth, as the touch flat panel mobile communication terminal 10 has the screen control unit 11, it provides enhanced usability than the conventional terminals in terms of touch-controlled functions.

Fifth, the touch flat panel mobile communication terminal 10 can be connected instantly to the computer host 20 upon being turned on without executing connection after booting like the a conventional notebook, PDA, smartphone, tablet computer, iPad or the like does, thus usability improves.

Sixth, the touch flat panel mobile communication terminal 10 fully takes the advantage of the wide popularity of the computer and deploys the processing capability of CPU in the personal computer without extra installation of unnecessary CPU hardware, thus is more eco-friendly.

Seventh, the touch flat panel mobile communication terminal 10 fully takes the advantage of the wide popularity of the computer and deploys the storage capability of memory in the personal computer without saving files on another mobile device to avoid file redundancy, thus is more eco-friendly and saves the trouble of file synchronization.

What is claimed is:

1. A touch flat panel mobile communication terminal equipped with computer processing functions, comprising:
a touch flat panel mobile communication terminal which includes a screen touch unit to receive control commands or input data from a user, a basic processing unit linked to the screen touch unit, a multimedia output unit linked to the basic processing unit, and a first transmitting/receiving unit linked to the basic processing unit; and
a computer host which includes and is connected to a second transmitting/receiving unit linked to the first transmitting/receiving unit, the touch flat panel mobile communication terminal being actively connected to the computer host when started;
wherein the screen touch unit receives input from the user, the basic processing unit transmitting the input via the first and second transmitting/receiving units to the computer host which correspondingly processes the input to generate multimedia data sent back to the touch flat panel mobile communication terminal via the first and second transmitting/receiving units, the multimedia data being output through the multimedia output unit to be accepted by the user.

2. The touch flat panel mobile communication terminal of claim 1, wherein the first and second transmitting/receiving units are connected via a wired network or a wireless network.

3. The touch flat panel mobile communication terminal of claim 1, wherein the screen touch unit is a human-machine interface.

4. The touch flat panel mobile communication terminal of claim 1, wherein the multimedia data is selected from the group consisting of audio, video, screen frames and combinations thereof.

5. The touch flat panel mobile communication terminal of claim 1, wherein the terminal is a standalone device to provide simple games or computer programs operated by the user.

6. The touch flat panel mobile communication terminal of claim 1, wherein the screen touch unit includes an additional device selected from the group consisting of a keyboard, a mouse, a trackball, a voice control interface and combinations thereof.
